(19) United States
(12) Patent Application Publication
(10) Pub. No.: US 2026/0360864 A1
(43) Pub. Date: Nov. 12, 2026

(54) BATTERY PACK COMPRISING A HEAT-TRANSFER FLUID CAPABLE OF CONTAINING THE THERMAL RUNAWAY OF THE ELECTROCHEMICAL ACCUMULATORS OF THE BATTERY PACK

(71) Applicant: SAFRAN ELECTRICAL & POWER, Blagnac cedex (FR)

(72) Inventors: Marc PONTRUCHER, MOISSY-CRAMAYEL (FR); Jean-François NICOLINO, MOISSY-CRAMAYEL (FR); Joel DEVAUTOUR, MOISSY-CRAMAYEL (FR)

(21) Appl. No.: 19/488,040

(22) PCT Filed: Jun. 12, 2024
(86) PCT No.: PCT/EP2024/066181

§ 371 Date: Nov. 25, 2025

(30) Foreign Application Priority Data
Jun. 14, 2023 (FR) FR2306054

(51) Int. Cl. H01M 10/6569; H01M 10/48; H01M 10/643; H01M 10/647; H01M 50/213; H01M 50/24; H01M 50/342; H01M 50/383

(52) U.S. Cl. CPC H01M 10/6569; H01M 10/482; H01M 10/643; H01M 10/647; H01M 50/213; H01M 50/24; H01M 50/3425; H01M 50/383

(57) ABSTRACT

A battery includes at least one electrochemical accumulator including an active portion and a casing containing the active portion; a housing which houses the at least one accumulator; and a heat-transfer fluid contained in the housing, the casing including a weakened area configured to open under the effect of overpressure in the accumulator and to discharge gases produced by the active portion of the accumulator which caused the overpressure. When the overpressure occurs in the at least one accumulator, the heat-transfer fluid comes into contact with the gases produced by the accumulator in such a way as to contain the gases and cool the accumulator.

### CROSS-REFERENCE TO RELATED APPLICATIONS

This application is a National Stage of International patent application PCT/EP2024/066181, filed on Jun. 12, 2024, which claims priority to foreign French patent application No. FR 2306054, filed on Jun. 14, 2023, the disclosures of which are incorporated by reference in their entireties.

### FIELD OF THE INVENTION

The invention relates to the field of batteries comprising electrochemical accumulators, in particular accumulators with liquid and/or gel electrolyte. They are composed of two electrodes (cathode and anode) separated by an isolating membrane (or separator), all of which is immersed in a liquid or gel electrolyte.

### BACKGROUND

A variety of chemical compounds are used to obtain high capacity accumulators. The most commonly used compound currently is associated with the technology family referred to as Lithium-Ion, and there are sub-families that use other combinations of chemical materials such as Lithium Iron Phosphate (LFP), Lithium Cobalt Oxide (LCO), Lithium Nickel Cobalt Aluminum Oxide (NCA) and Lithium Nickel Manganese Cobalt Oxide (NMC). In addition to these sub-families, other combinations are being studied with solid Lithium and Lithium-Air compounds. Another family of technologies is emerging to address the problem of lithium supply: Sodium-Ion technology.

These accumulators have high energy capacities to meet the needs of applications. A high energy capacity is particularly useful in the transport sector. These accumulators are assembled into battery packs for integration into propulsion systems, which are referred to as all-electric when the battery (or battery pack) is the sole source of energy or hybrid when the battery pack shares the supply of energy with another energy source. These accumulators are also used to create high capacity battery packs to meet what are referred to as stationary energy storage needs, such as the storage of renewable energy on electrical networks. The fields of application are wide-ranging and are not limited to land and air transport or electrical networks. Thus, the present invention is applicable to all fields which may use high capacity electrochemical accumulators that are subject to thermal runaway under adverse conditions of use.

The cause of thermal runaway may be linked to detrimental changes internal to the accumulator (damage to the accumulator materials generating an internal short circuit, such as perforation of a separator owing to the formation of dendrites). FIG. 1 schematically shows a perforation P of an accumulator separator S between an anode A and a cathode C. Thermal runaway may also be linked to adverse external environmental conditions (temperature, vibration, impacts) and/or operating conditions during the charging or discharging of the accumulator.

These internal detrimental changes or adverse conditions of use give rise to thermal heating inside the elementary accumulators which leads to thermal runaway of the accumulators and can result in fumes/gas or even fire.

By way of illustration, when hot, an electrochemical accumulator must operate within a defined range of temperatures, generally below 70 °C on its outer surface. Outside of this defined range of temperatures, the materials constituting the accumulator become damaged and this is the cause of thermal runaway in the accumulator. Thermal runaway persists in the accumulator when the energy released by the exothermic reactions occurring inside it exceeds the capacity to dissipate this energy to the exterior, and also when the faulty accumulator cannot be isolated to cool it down.

Furthermore, in this type of battery, thermal runaway can start in one accumulator and spread to one or more neighboring accumulators, or even to the entire battery.

It is therefore necessary to contain the thermal runaway of battery accumulators.

Solutions for cooling batteries do exist. For example, known document DE 122013017396A1 discloses a battery comprising a housing in which cells/accumulators are arranged. The cells are bathed in a fluid contained within the housing in order to control their temperature.

### SUMMARY OF THE INVENTION

The invention aims to improve this solution not only by cooling the accumulators but above all, in the event of thermal runaway starting in an accumulator, by confining the thermal runaway to the accumulator concerned alone.

To this end, the invention proposes a battery comprising:
at least one electrochemical accumulator comprising an active portion and a casing containing said active portion;
a housing which houses said at least one accumulator; and
a heat-transfer fluid contained in the housing,
   the casing comprising a weakened area configured to open under the effect of overpressure in the accumulator and to discharge gases produced by the active portion of the accumulator which caused the overpressure.
   When the overpressure occurs in said at least one accumulator, said heat-transfer fluid comes into contact with the gases produced by the accumulator in such a way as to contain said gases and cool the accumulator.
   When overpressure occurs in said at least one accumulator, the heat-transfer fluid in contact with the gases produced by the accumulator changes from a liquid phase to a gas phase.

The solution provided by the invention thus makes it possible to contain the onset of thermal runaway causing overpressure in the faulty accumulator by directly containing the gases produced by the accumulator. Opening the weakened area of the casing of the faulty accumulator allows the fluid to quickly access the gases produced by the accumulator, and thus to contain the thermal runaway as close as possible to its origin and prevent it from progressing to the core of the accumulator.

The invention reduces the risk of thermal runaway spreading to adjacent cells by directly and rapidly cooling the faulty accumulator.

Particularly useful preferred features of the battery according to the invention are presented below.

When overpressure occurs in said at least one accumulator, the heat-transfer fluid enters through the open weakened area in such a way as to contain at least some of the gases produced by the accumulator.

When overpressure occurs in said at least one accumulator, the heat-transfer fluid comes into contact, outside the accumulator, with at least some of the gases discharged.

The heat-transfer fluid has a liquid/gas phase change temperature higher than a skin temperature during thermal runaway that causes the weakened area of said at least one electrochemical accumulator to open.

The casing comprises a structural weakness forming the weakened area, the weakened area being configured to open by rupturing under the effect of overpressure in the accumulator.

The heat-transfer fluid is a non-flammable oil.

The heat-transfer fluid has a viscosity of between 0.3 mm²·s and 5 mm²·s, preferably between 1 mm²·s and 5 mm²·s.

The battery further comprises a bladder assembled to the housing and configured to absorb variations in pressure within the housing.

The battery further comprises a pressure sensor configured to detect overpressure in the housing.

The housing comprises a valve configured to open upon overpressure in the housing and/or in said at least one accumulator.

The battery comprises several accumulators and several casings, the accumulators being arranged in series or in parallel in the housing, each casing containing one of the accumulators.

### BRIEF DESCRIPTION OF THE DRAWINGS

Further features and advantages of the invention will become apparent from the following description with reference to the attached drawings, provided by way of non-limiting example:

FIG. 1 schematically depicts an accumulator comprising a perforated separator;

FIG. 2 schematically depicts a battery pack according to an embodiment of the invention;

FIG. 3 depicts an accumulator of the battery pack;

FIG. 4 is a detail view of FIG. 3;

FIG. 5 depicts the battery pack according to another embodiment; and

FIG. 6 is a view in cross section of the battery pack in FIG. 5.

### DETAILED DESCRIPTION

FIG. 2 depicts a battery or battery pack 1 according to an example of an embodiment of the invention.

The battery pack 1 comprises a housing 2 and several electrochemical accumulators or cells 3.

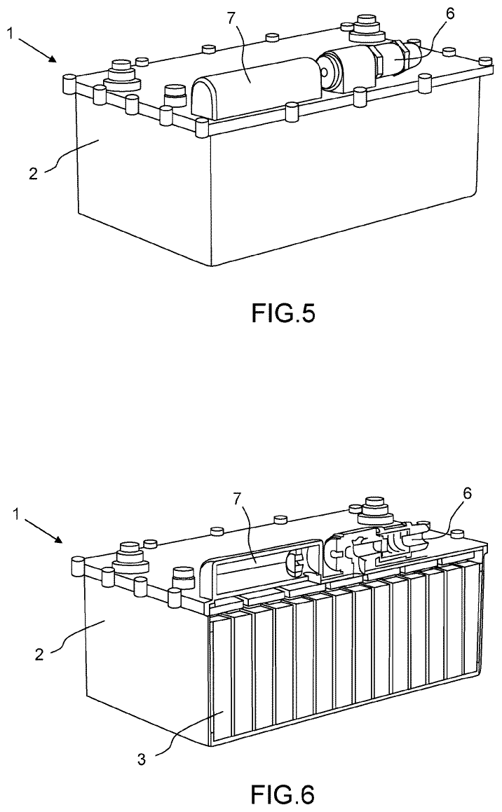

An upper wall of the housing 2 is not shown in FIG. 2 but is visible in FIGS. 5 and 6 depicting another embodiment.

The housing 2 is preferably rigid. The housing 2 may be made of metal or composite.

The housing 2 in this case has a parallelepiped shape but may of course have a different shape.

The accumulators 3 are arranged in series or in parallel in the housing 2. The accumulators 3 in one and the same housing 2 form a module. Fourteen accumulators 3 are shown in FIG. 2.

The modules form a first barrier to the propagation of a fault in an accumulator 3. The presence of modules is optional. In the absence of a module, all the accumulators are grouped together in a single housing. Module integration is dictated by considerations of manufacturability and maintenance of the battery pack.

The battery pack may comprise a housing (not shown) housing all the modules. In other words, said housing houses several housings 2.

The accumulators 3 are connected to one another, typically by connection bars 4, usually referred to as busbars. The busbars 4 are for example screwed or welded to the accumulators 3. The busbars 4 allow the electrical connection between the accumulators 3.

The modules are also connected to one another, notably by busbars 4.

The busbars 4 are for example made of copper.

Battery packs for applications requiring a high energy capacity comprise several electrochemical accumulators connected in series-parallel to meet the voltage, energy and power requirements of the intended application. The voltage level is obtained by connecting the accumulators in series, and the energy and power level is obtained by connecting the accumulators in parallel. For safety reasons, to achieve the voltage, energy and power levels it is necessary to group the accumulators together to form a module. The modules are then positioned in series-parallel to meet the specifications of the intended application.

For example, each module comprises up to sixteen accumulators 3 connected in series, each module having a voltage of 60 V. Nine modules may be connected to one another to obtain the desired voltage, for example 540 V in the case of a series connection of all the modules.

Each electrochemical accumulator 3 comprises an active portion and a casing 300.

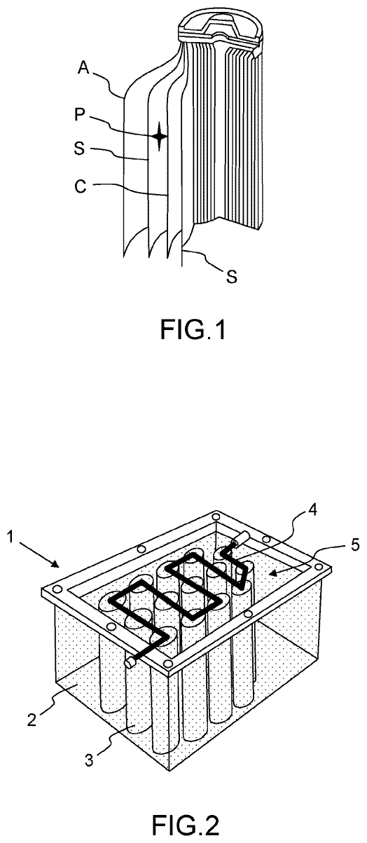

The active portion of the accumulator 3 comprises two electrodes, namely a cathode and an anode. The active portion also comprises at least one separator to isolate the electrodes from one another. The assembly may be impregnated with a liquid or gel electrolyte. The active portion of the accumulator thus comprises the electrodes, at least one separator, and an electrolyte. For the sake of simplicity, these components or active portion of the accumulator 3 are not shown in FIGS. 2 to 5 but are shown in FIG. 1 which provides a simplified view of the architecture of the accumulator 3.

Each casing 300 contains the active portion of one of the accumulators 3. The casing 300 is sealed or tight.

The casing 300 is generally rigid (hard). The rigid casing 300 is made, for example, from a metal such as aluminum, nickel or steel. According to another example of an embodiment, the casing 300 may be flexible. The flexible casing 300 is made using materials such as nylon.

In the example illustrated in FIGS. 2 to 4, the casing 300 has a cylindrical shape. The casing 300 comprises a side wall 301 and transverse walls 302.

A transverse plane means a plane orthogonal to a median plane of the casing passing through a height of the casing.

The casing 300 may have a different shape, for example prismatic (as in FIG. 6), button cell (cylindrical and flat) or a “pouch” format.

The casing 300 may be formed in one piece or comprise several parts.

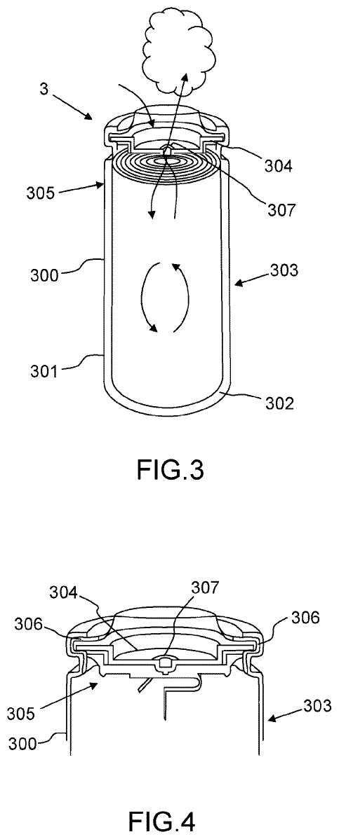

In the example shown in FIGS. 3 and 4, the casing 300 comprises several parts. In particular, the casing 300 comprises a main body 303 and a closure disk 304.

The main body 303 is in this case substantially cylindrical. The main body 303 is notably cylindrical, the accumulator 3 having a generally cylindrical shape. Alternatively, the main body 303 may have other shapes, for example oblong, oval, or with straight edges and rounded ends.

The main body 303 has a transverse opening 305 at one end.

The closure disk 304 is assembled to the main body 303. The closure disk 304 closes the transverse opening 305 of the main body 303. The closure disk 304 thus forms one of the transverse walls 302 of the casing 300.

The casing 300 also comprises a seal 306. The seal 306 is arranged between the main body 303 and the closure disk 304.

The casing 303 comprises a weakened area 307 configured to open under the effect of overpressure in the accumulator 3. The weakened area 307 is an area in which the casing 300 is weakened such that said area is the first to open in the event of overpressure in the accumulator 3. In other words, the casing 300 may have a structural weakness forming the weakened area 307.

The weakened area 307 is calibrated and set to open at a certain pressure threshold or level. Overpressure may occur in an accumulator 3 during thermal runaway of the latter. This phenomenon is described in detail further below.

The structural weakness acts as a mechanical fuse. The structural weakness may typically be a reduction in the thickness of the casing 300 over an area of the casing 300. The structural weakness may also be a local weak spot, for example formed by marking or punching, on one of the walls of the casing 300.

The weakened area 307 is in this case formed in the transverse wall, in this case the closure disk 304. The weakened area 307 is formed by a boss made on the closure disk 304. The boss is for example made by punching in order to locally weaken the closure disk 304. The thickness of the boss is thinner than the rest of the closure disk.

The weakened area 307 may be provided elsewhere in the casing 300, for example in the side wall 301.

The weakened area 307 may be formed and/or have a shape other than a boss.

The weakened area 307 is configured to open by rupturing under the effect of overpressure in the accumulator 3. When overpressure occurs, the weakened area 307 deforms, to the point where the casing 300 opens in said weakened area 307. The size of the opening becomes larger and larger depending on the pressure of the gases released by the accumulator 3.

The battery pack 1 also comprises a heat-transfer fluid 5. The heat-transfer fluid is contained within the housing. The casing of each accumulator 3 is thus in contact with the heat-transfer fluid.

The heat-transfer fluid 5 is higher than the accumulators 3. In other words, the heat-transfer fluid 5 covers the accumulators 3.

The housing 2 may be vacuum-filled with heat-transfer fluid 5. This ensures a good distribution of the heat-transfer fluid 5 over all the accumulators 3 and prevents air bubbles from being trapped in the housing 2 which could prevent contact between the heat-transfer fluid 5 and the accumulators 3.

The battery pack 1 has an oil presence sensor to detect any leaks in the housing of the pack.

The heat-transfer fluid 5 has a viscosity such that, in the event of overpressure in one of the accumulators 3, the heat-transfer fluid 5 enters through the open weakened area 307 in such a way as to cool the accumulator 3.

Typically, the heat-transfer fluid 5 has a viscosity of between 0.3 mm²·s and 5 mm²·s, preferably between 1 mm²·s and 5 mm²·s.

The heat-transfer fluid 5 is preferably non-flammable to avoid causing a fire inside the battery pack 1.

The heat-transfer fluid 5 is advantageously an oil.

Preferably, the heat-transfer fluid 5 is a synthetic oil.

Preferably, the oil does not have a flash point or auto-ignition temperature. In other words, the oil has the feature of being non-flammable, for example a non-flammable fluorinated oil.

According to another example of an embodiment, the heat-transfer fluid 5 may be water, in particular demineralized water.

Upon thermal runaway of an accumulator 3, the temperature at the core of the accumulator 3 rises until it becomes uncontrollable. In particular, the temperature at the core of the accumulator 3 rises until it reaches a thermal runaway temperature Te. Because the accumulator 3 is sealed by virtue of the casing 300, the pressure in the accumulator 3 rises. When the accumulator 3 is overpressurized, the weakened area 307 opens. The weakened area 307 releases the electrolyte from the accumulator 3 in the form of flammable gases.

The accumulator 3 is overpressurized when it exceeds a threshold pressure Ps. This is a consequence of the rise in temperature in the accumulator 3. The threshold pressure Ps is for example between 13 and 15 bar. The threshold pressure Ps is notably between 13 and 15 bar for cylindrical accumulator formats 18650.

Thermal runaway temperature Te means a temperature threshold beyond which the temperature inside the accumulator rises uncontrollably. This threshold is reached when the exothermic reaction that occurs following a fault or misuse of the accumulator cannot be cooled. In this case, the temperature continues to rise, feeding off itself through this increase in temperature, and the faulty accumulator enters into a positive feedback process.

The thermal runaway temperature Te depends in particular on the components of the accumulator 3 and also on the state of charge (SoC) of the accumulator 3. The thermal runaway temperature Te is ascertained by measuring the skin temperature of the accumulator 3. The accumulator 3 is considered to have gone into thermal runaway when the skin temperature Tp of the accumulator 3, that is to say the temperature taken on an outer surface of the walls 301, 302 of the casing, reaches a temperature range between 70 °C and 120 °C. The temperatures of the gases generated by the thermal runaway at the core of the accumulator can exceed 800 °C or even 1000 °C

In the event of overpressure in the accumulator 3 caused by thermal runaway, the casing 300 of the accumulator 3 deforms. The pressure rises inside the accumulator 3, deforming the casing 300 and eventually opening the weakened area 307.

The gases generated inside the accumulator 3 by the exothermic reaction are released when the weakened area 307 opens, the pressure threshold Ps having been reached. Depending on the magnitude of the reaction, the casing may also open at other locations on the casing 300, creating an opening in the casing through which the gases escape.

The gases discharged at least in part from the accumulator through the weakened area 307 are at least at the thermal runaway temperature or even at a higher temperature. The gases come into contact with the heat-transfer fluid 5 which changes phase, thus absorbing the heat energy discharged by these hot gases. The heat-transfer fluid 5 thus contains the temperature locally. The heat-transfer fluid 5 comes into contact with the gases produced by the accumulator 3 outside and/or inside the accumulator. The heat-transfer fluid may come into contact with the gases discharged through the weakened area. The heat-transfer fluid 5 may also come into contact with the gases inside the accumulator 3. The heat-transfer fluid 5 enters through the weakened area 307 of the casing 300 of the accumulator 3 and diffuses inside, mixing with the electrolyte and getting closer to the origin of the thermal runaway. The heat-transfer fluid 5 comes into contact with the core of the accumulator 3. The incoming heat-transfer fluid 5 migrates toward the core of the accumulator 3 and therefore close to the central point of heating to smother same. This prevents the thermal runaway from continuing to progress both inside and outside the accumulator 3. This also helps to prevent the thermal runaway from spreading to neighbouring accumulators 3. It is thus possible to contain the source of the fault.

In other words, the present invention takes advantage of the property of the latent heat of vaporization of the heat-transfer fluid 5 to contain the thermal runaway of the faulty accumulator inside the accumulator when the latter opens when thermal runaway occurs. The heat-transfer fluid 5 enters the accumulator 3 and becomes diluted with the electrolyte liquid of the accumulator 3, gradually coming into contact with the area where the thermal hot spot has formed. In yet other words, the heat-transfer fluid 5 enters the accumulator 3, helping to get as close as possible to the hot spot that has been created in the accumulator 3. This makes it possible to take action as close as possible to the fault and thus smother the hot spot.

The heat-transfer fluid 5, in contact with the hot gases exiting the accumulator 3, changes from a liquid phase to a gas phase.

The heat-transfer fluid 5 has a liquid/gas phase change temperature Tc. Preferably, the heat-transfer fluid 5 has a liquid/gas phase change temperature Tc higher than the skin temperature Tp of the casing. Thus, in the event of thermal runaway, the heat-transfer fluid 5 around the accumulator 3 remains liquid. Heat exchange then takes place with the walls 301, 302 of the accumulator 3.

The liquid/gas phase change temperature Tc is higher than the skin temperature Tp of the casing when the weakened area 307 is open. For example, thermal runaway generates a rise in internal temperature such that the skin temperature Tp of the accumulator reaches a temperature of between 70 °C and 120 °C and such that this rise in temperature also causes the weakened area 307 to open, releasing hot gases. The liquid/gas phase change temperature Tc is selected such that the phase changes when the heat-transfer fluid is in contact with the hot gases. This change of phase may take place between 80 °C and 250 °C depending on the heat-transfer fluid selected. The liquid/gas phase change threshold or temperature Tc of the heat-transfer fluid 5 is thus defined in relation to the skin temperature threshold Tp when thermal runaway causes the weakened area 307 to open. This makes it possible to take advantage of the phase change of the heat-transfer fluid at the moment when the hot gases exit the accumulator. Since the temperatures of the hot gases exiting the accumulator are linked to the chemical components constituting the accumulator and also to the energy stored in the accumulator at the time of thermal runaway, they range from 70 °C at the start of thermal runaway and rise very quickly to 400 °C, reaching 1000 °C if no measures are taken to contain the reaction. Note that the casing 300 necessarily opens in the weakened area 307, the latter being calibrated for such an opening in the event of overpressure. It is possible that the casing 300 may also open in other locations, depending in particular on the intensity of the reaction within the accumulator 3, allowing the heat-transfer fluid 5 to come into contact with the discharged gases also at these locations.

The incoming heat-transfer fluid 5 enters the hot spot and evaporates on contact with the hot parts, limiting the rise in temperature. The heat-transfer fluid 5 acts as a heat extractor. The heat-transfer fluid 5 prevents the remaining material in the faulty accumulator 3 from contributing to the thermal runaway. The heat-transfer fluid 5 stabilizes and then stops the thermal runaway inside the accumulator 3. Thus, by containing the thermal runaway at the source, this solution prevents this thermal runaway from spreading to adjacent accumulators 3.

The properties of the heat-transfer fluid 5 are adapted to the needs of the accumulators 3 to contain their thermal runaway for the liquid/gas phase change temperature Tc. The thermal runaway threshold Te differs depending on the chemistry of the accumulator and the energy stored at the time of thermal runaway. Consequently, the formulation of the heat-transfer fluid 5 must be adapted to have a liquid/gas phase change threshold Tc which is compatible with the thermal runaway threshold Te.

The viscosity of the heat-transfer fluid 5 may be selected in such a way as to allow the heat-transfer fluid 5 to enter the accumulator 3 when the weakened area 307 of the casing 300 opens. In the event that the casing 300 opens also in other locations, other than the weakened area 307, the viscosity of the heat-transfer fluid 5 of course also facilitates the entry of the heat-transfer fluid into the accumulator 3. Note that the heat-transfer fluid 5, which changes to a gas phase on coming into contact with the gases produced by the accumulator 3, becomes more viscous as the temperature increases. This further facilitates the entry of the heat-transfer fluid 5 into the accumulator 3.

Furthermore, when the heat-transfer fluid 5 is a synthetic oil, this allows for better cooling of the accumulators 3 under nominal operating conditions, because the oil spreads throughout the housing 2 and ensures uniform contact over all the walls of the accumulators 3 and therefore good heat exchange. The oil, with its intrinsic dielectric strength properties, also facilitates the integration of high-voltage batteries by reducing the isolation distances of the parts subjected to high voltage and avoids the risk of breakdown between the parts subjected to high voltage and the walls of the housing 2 of the battery pack in which the elementary accumulators 3 are integrated and/or of a housing of the module in the case of integration into the battery pack with modules.

As an illustrative example, the thermal runaway temperature Te starts between 70 °C and 120 °C and increases to reach temperatures of around 400 to 800 °C, or even 1000 °C. The external temperature Tp of the casing 300 is between 70 °C and 120 °C depending on the composition of the accumulators and the state of charge of the accumulator at the time of thermal runaway. Under these conditions, the heat-transfer fluid 5 is selected such that it has a liquid/gas phase change temperature Tc higher than the external temperature Tp of the casing 300, for example of the order of 130 °C

Preferably, the accumulators 3 are separated from one another by a distance of at least 1 mm. This allows the heat-transfer fluid 5 to efficiently cool the accumulators 3.

The battery pack 1 may also comprise a bladder 6 assembled to the housing 2 (visible in the example of an embodiment shown in FIGS. 5 and 6). The bladder 6 is configured to absorb variations in pressure inside the casing. The bladder 6 may be elastic and inflatable.

The bladder 6 initially compensates for the overpressure produced upon failure of an accumulator 3 and prevents this overpressure from being borne by the walls of the housing 2 of the battery pack 1.

The bladder may also compensate for variations in pressure related to the expansion of the heat-transfer fluid as a function of environmental conditions (temperature, altitude).

The bladder may be made of aluminum.

One or more bladders may be arranged as needed. For example, bladders may be positioned at module level or at battery pack level.

The battery pack 1 may also comprise a pressure sensor (not shown). The pressure sensor is configured to measure a pressure in the housing 2 and/or to detect overpressure in the housing.

The pressure sensor may be integrated into the bladder 6.

In another example, the pressure sensor may be mounted on an internal wall of the housing 2.

The pressure sensor is configured to generate, via a contactor, an electrical signal corresponding to information representative of said pressure.

The pressure sensor may be configured to send a warning signal in the event of overpressure in the housing.

The pressure sensor may also be configured to give an isolation command for the battery pack by opening a contactor at the output of the battery pack 1.

The heat-transfer fluid presence sensor is present in the battery pack 1 (not shown). It is configured to detect any leak of heat-transfer liquid.

When thermal runaway occurs, it is not necessarily detected electrically; the modules may continue to operate given the large number of accumulators. The pressure sensor therefore makes it possible to detect overpressure as early as possible. When the heat-transfer fluid 5 vaporizes, the pressure rises, and this is detected by the pressure sensor which may open the contactor at the output of the battery pack 1.

The housing may also comprise a valve 7 (visible in FIGS. 5 and 6) configured to open when overpressure occurs in the battery pack 1 and/or in the housing 2 of one of the modules.

The valve 7 comprises, for example, ducts allowing fumes to escape to the outside of the housing 2 in the event of a malfunction of the battery pack 1.

The valve 7 also allows the discharge of fumes from the heat-transfer fluid in the event of release of gas from one or more accumulators 3 which could go into thermal runaway simultaneously.

Of course, the present invention is not limited to the embodiments described and illustrated.

For example, in the case where a housing houses a set of modules, the heat-transfer fluid may also be contained in said housing.

The invention affords a reduction in the risk or even prevents a fire starting when the accumulator goes into thermal runaway. The properties of the heat-transfer fluid facilitate heat exchange between the accumulator and the outside by boiling as close as possible to the threshold that triggers the accumulator into thermal runaway. This boiling and the infiltration of the heat-transfer fluid through the weakened area of the casing of the accumulator experiencing runaway help to contain the runaway and reduce the reach of flames and hot fumes that may escape from the accumulator upon the occurrence of such a fault. In addition, the heat-transfer fluid absorbs the overpressure generated when the accumulator explodes, thus reducing mechanical stresses in the casing and the housing of the battery pack.

Thanks to the cooling of components by the heat-transfer fluid, the invention makes it possible to cool the accumulators in nominal operating mode and to indirectly improve the reliability of the accumulators.

It also reduces the risk of or even stops the thermal runaway from spreading to adjacent accumulators.

The solution, through direct contact between the heat-transfer fluid and the accumulator which is experiencing thermal runaway, makes it possible to trigger phase change of the heat-transfer fluid, absorbing the energy released by the faulty accumulator and helping to contain the thermal runaway.

Thanks to the use of a heat-transfer fluid such as non-flammable synthetic oils, these fluids have dielectric properties that help reduce the risk of electric arcing for high voltage batteries.

The invention benefits all types of batteries subject to thermal runaway, particularly in cases of extreme use such as those listed below, but not limited to impacts, internal and external short circuits and adverse temperature conditions.

1. A battery comprising:
at least one electrochemical accumulator comprising an active portion and a casing containing said active portion;
a housing which houses said at least one accumulator; and
a heat-transfer fluid contained in the housing,
the casing comprising a weakened area configured to open under the effect of overpressure in the accumulator and to discharge gases produced by the active portion of the accumulator which caused the overpressure,
wherein, when the overpressure occurs in said at least one accumulator, said heat-transfer fluid comes into contact with the gases produced by the accumulator in such a way as to contain said gases and cool the accumulator, and wherein the heat-transfer fluid in contact with the gases produced by the accumulator changes from a liquid phase to a gas phase.

2. The battery as claimed in claim 1, wherein when overpressure occurs in said at least one accumulator, said heat-transfer fluid enters through the open weakened area in such a way as to contain at least some of the gases produced by the accumulator.

3. The battery as claimed in claim 1, wherein when overpressure occurs in said at least one accumulator, said heat-transfer fluid comes into contact, outside the accumulator, with at least some of the gases discharged.

4. The battery as claimed in claim 1, wherein the heat-transfer fluid has a liquid/gas phase change temperature (Tc) higher than a skin temperature (Tp) during thermal runaway that causes the weakened area of said at least one electrochemical accumulator to open.

5. The battery as claimed in claim 1, wherein the casing comprises a structural weakness forming the weakened area, the weakened area being configured to open by rupturing under the effect of overpressure in the accumulator.

6. The battery as claimed in claim 1, wherein the heat-transfer fluid is a non-flammable oil.

7. The battery as claimed in claim 1, wherein the heat-transfer fluid has a viscosity of between 0.3 mm²·s and 5 mm²·s, preferably between 1 mm²·s and 5 mm²·s.

8. The battery as claimed in claim 1. further comprising a bladder assembled to the housing and configured to absorb variations in pressure within the housing.

9. The battery as claimed in claim 1, further comprising a pressure sensor configured to detect overpressure in the housing.

10. The battery as claimed in claim 1, wherein the housing comprises a valve configured to open upon overpressure in the housing and/or in said at least one accumulator.

11. The battery as claimed in claim 1, wherein the housing comprises an oil presence sensor configured to detect any leak of heat-transfer liquid in the housing.

12. The battery as claimed in claim 1, comprising several accumulators and several casings the accumulators being arranged in series or in parallel in the housing each casing containing one of the accumulators.
